(19) United States
(12) Patent Application Publication
(10) Pub. No.: US 2026/0028035 A1
(43) Pub. Date: Jan. 29, 2026

(54) SIDE VIEW CAMERA RESOLUTION TESTING AND DIRTY LEFTOVER DETECTION AND AUTO-CLEAN/WARNING TRIGGER

(71) Applicant: GM Global Technology Operations LLC, Detroit, MI (US)

(72) Inventors: Manoj Kumar Sharma, Troy, MI (US); Julien P. Mourou, Bloomfield Hills, MI (US); Jonglee Park, Novi, MI (US); Charles R. Quinn, Pleasant Ridge, MI (US)

(21) Appl. No.: 18/787,084

(22) Filed: Jul. 29, 2024

(51) Int. Cl. B60W 50/14; G01M 11/02; G02B 27/00

(52) U.S. Cl. CPC B60W 50/14; G01M 11/0257; G01M 11/0292; G02B 27/0006; B60W 2050/143; B60W 2050/146; B60W 2420/403

(57) ABSTRACT

A vehicle includes an imaging device which operates a camera. The imaging device includes a and a processor. The processor obtains a first image of a test object via the camera, determines a resolution of the first image, determines a contrast ratio of the first image when the resolution is less than a resolution threshold, compares the contrast ratio to a contrast threshold, activates the cleaning system to clean the camera when the contrast ratio is less than the contrast threshold, obtains a second image of the test object, and sends an alert signal to a driver of the vehicle based on the second image.

The subject disclosure relates to vehicle-based imaging systems and, in particular, to a system and method for testing camera resolution and detecting a presence of debris on a camera of a vehicle-based imaging system by computing an image contrast, thereby implementing a cleaning process for the camera.

Vehicles currently can be produced that replace a side view mirror with an imaging system that includes a camera coupled to a monitor. The camera is outside the vehicle and the monitor is inside the vehicle at a convenient viewing location for a driver of the vehicle. A resolution of the camera is defined by its ability to separate the smallest possible features in an image. For proper image resolution, the camera has to function at a minimum resolution. Dirt, water and/or other debris can accumulate at a lens or at a glass surface of the camera, thereby impacting a contrast of an image captured by the camera. Accordingly, it is desirable to provide a system and method for cleaning the debris from the camera.

### SUMMARY

In one exemplary embodiment, a method of operating a camera of an imaging device of a vehicle is disclosed. The method includes obtaining a first image of a test object via the camera, the camera including an image sensor with an array of pixels, determining a resolution of the first image, comparing the resolution to a resolution threshold, determining a contrast ratio of the first image at a processor when the resolution is less than the resolution threshold, wherein the contrast ratio is based on a difference between a first gray scale value for a first pixel of the first image having a maximum intensity and a second gray scale value for a second pixel of the first image having a minimum intensity, comparing the contrast ratio to a contrast threshold at the processor, performing, via the processor, a cleaning operation to clean the camera when the contrast ratio is less than the contrast threshold, obtaining a second image of the test object, and sending an alert signal to a driver of the vehicle based on the second image.

In addition to one or more of the features described herein, the method further includes segmenting the first image into at least a first region and a second region, determining a first contrast ratio for the first region and a second contrast ratio for the second region, and performing the cleaning operation when at least one of the first contrast ratio and the second contrast ratio is less than the contrast threshold.

In addition to one or more of the features described herein, the method further includes determining the resolution of the first image using a modulation transfer function.

In addition to one or more of the features described herein, the test object is at least one of a door handle of the vehicle, a tail light of the vehicle, a test pattern printed on the vehicle within a field of view of the camera, and a set of LEDs on the vehicle and within the field of view of the camera.

In addition to one or more of the features described herein, the method further includes performing the cleaning operation at a subsequent time when the contrast ratio of the second image is less than the contrast threshold.

In addition to one or more of the features described herein, the alert signal is at least one of a visual signal and an audio signal.

In addition to one or more of the features described herein, the method further includes sending the alert signal when at least one of the resolution of the second image is less than the resolution threshold and the contrast ratio of the second image is less than the contrast threshold.

In another exemplary embodiment, an imaging device for a vehicle is disclosed. The imaging device includes a camera including an array of pixels, a cleaning system, and a processor. The processor is configured to obtain a first image of a test object via the camera, determine a resolution of the first image, compare the resolution to a resolution threshold, determine a contrast ratio of the first image when the resolution is less than the resolution threshold, wherein the contrast ratio is based on a difference between a first gray scale value for a first pixel of the first image having a maximum intensity and a second gray scale value for a second pixel of the first image having a minimum intensity, compare the contrast ratio to a contrast threshold, activate the cleaning system to clean the camera when the contrast ratio is less than the contrast threshold, obtain a second image of the test object, and send an alert signal to a driver of the vehicle based on the second image.

In addition to one or more of the features described herein, the processor is further configured to segment the first image into at least a first region and a second region, determine a first contrast ratio for the first region and a second contrast ratio for the second region, and activate the cleaning system when at least one of the first contrast ratio and the second contrast ratio is less than the contrast threshold.

In addition to one or more of the features described herein, the processor is further configured to determine the resolution of the first image using a modulation transfer function.

In addition to one or more of the features described herein, the test object is at least one of a door handle of the vehicle, a tail light of the vehicle, a test pattern printed on the vehicle within a field of view of the camera, and a set of LEDs on the vehicle and within the field of view of the camera.

In addition to one or more of the features described herein, the processor is further configured to activate the cleaning system at a subsequent time when the contrast ratio of the second image is less than the contrast threshold.

In addition to one or more of the features described herein, the imaging device further includes an interface for providing the alert signal to the driver as at least one of a visual signal, and an audio signal.

In addition to one or more of the features described herein, the camera is located at a side of the vehicle.

In yet another exemplary embodiment, a vehicle is disclosed. The vehicle includes a test object located on the vehicle and an imaging system. The imaging system includes a camera including an image sensor having an array of pixels, a cleaning system for cleaning a glass surface of the camera, and a processor. The processor is configured to obtain a first image of the test object via the camera, determine a resolution of the first image, compare the resolution to a resolution threshold, determine a contrast ratio of the first image when the resolution is less than the resolution threshold, wherein the contrast ratio is based on a difference between a first gray scale value for a first pixel of the first image having a maximum intensity and a second gray scale value for a second pixel of the first image having a minimum intensity, compare the contrast ratio to a contrast threshold, activate the cleaning system to clean the camera when the contrast ratio is less than the contrast threshold, obtain a second image of the test object, and send an alert signal to a driver of the vehicle based on the second image.

In addition to one or more of the features described herein, the processor is further configured to segment the first image into at least a first region and a second region, determine a first contrast ratio for the first region and a second contrast ratio for the second region, and activate the cleaning system when at least one of the first contrast ratio and the second contrast ratio is less than the contrast threshold.

In addition to one or more of the features described herein, the processor is further configured to determine the resolution of the first image using a modulation transfer function.

In addition to one or more of the features described herein, the test object is at least one of a door handle of the vehicle, a tail light of the vehicle, and a test pattern printed on the vehicle within a field of view of the camera, and a set of LEDs on the vehicle and within the field of view of the camera.

In addition to one or more of the features described herein, wherein the processor is further configured to activate the cleaning system at a subsequent time when the contrast ratio of the second image is less than the contrast threshold.

In addition to one or more of the features described herein, vehicle further includes an interface for providing the alert signal to a driver as at least one of a visual signal and an audio signal.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a plan view of a vehicle in accordance with an exemplary embodiment;

FIG. 2 shows a perspective view of the vehicle at a driver's side of the vehicle;

FIG. 3 is a flowchart of a method for operating a cleaning system of the camera, in an embodiment;

FIG. 4 is an image of a remote vehicle having headlights directed toward a camera;

FIG. 5 shows graphs of various levels of resolution for two points;

FIG. 6 shows a flowchart of a method of determining a resolution of an image in illustrative embodiment;

FIG. 7 shows a flowchart illustrating a method for cleaning a camera of the imaging device based on a contrast ratio for the image, in an embodiment;

FIG. 8 shows a flowchart illustrating a method for determining a terminus for a cleaning operation, in an embodiment;

FIG. 9 shows an illustrative image of a test pattern having black (low intensity) and white (high intensity) portions;

FIG. 10 shows a second image of the test pattern taken by a camera experiencing a reduced image contrast due to a light accumulation of water;

FIG. 11 shows a third image of the test pattern taken by the camera experiencing a reduced image contrast due to a heavy accumulation of water; and

FIG. 12 shows a fourth image of the test pattern taken by the camera experiencing a reduced image contrast due to an accumulation of dirt.

### DETAILED DESCRIPTION

The following description is merely exemplary in nature and is not intended to limit the present disclosure, its application or uses. It should be understood that throughout the drawings, corresponding reference numerals indicate like or corresponding parts and features.

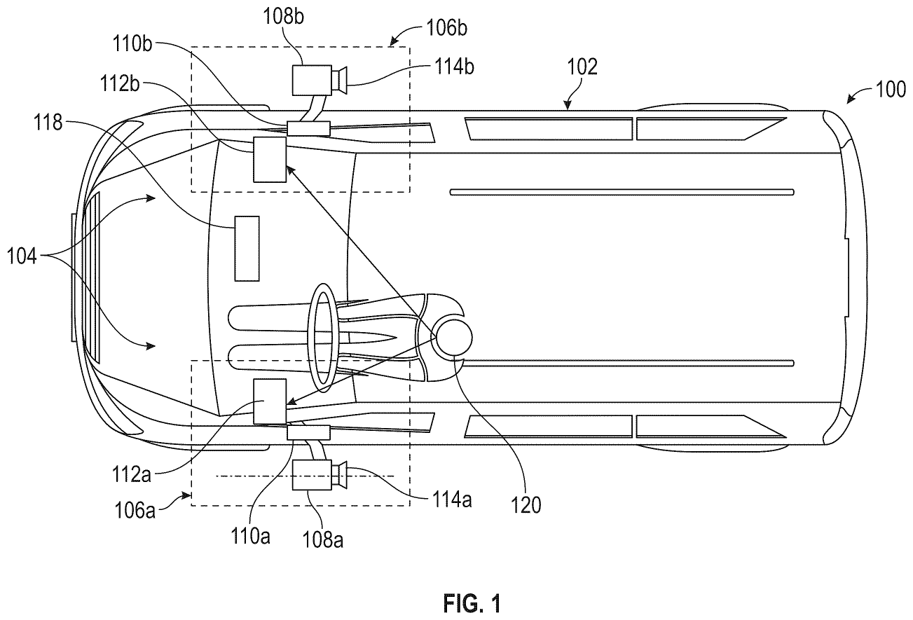

In accordance with an exemplary embodiment, FIG. 1 shows a plan view 100 of a vehicle 102. The vehicle 102 includes an imaging system 104. The imaging system 104 can be a side view imaging system that replaces one or more side view mirrors of the vehicle. For illustrative purposes, the imaging system 104 includes a first imaging device 106a located at a driver's side of the vehicle and a second imaging device 106b located at a passenger's side of the vehicle. The first imaging device 106a includes a first camera 108a, a first processor 110a, a first monitor 112a and a first cleaning system 114a. Other embodiments of the imaging system 104 can include imaging devices with cameras oriented at other possible directions, either in place of, or in addition to, the first imaging device 106a and the second imaging device 106b.

The first camera 108a can be disposed on an outer surface of a driver's side door of the vehicle 102. The first monitor 112a is located interior to the vehicle, such as on an inner surface of driver's side door. The first monitor 112a can be a flat panel display, such as a light emitting diode (LED) display, and directs an image captured by the first camera 108a towards a driver 120 or occupant of the vehicle 102. The first processor 110a is coupled to the first camera 108a and the first monitor 112a. An image captured by the first camera 108a is sent to the first processor 110a, which sends the image to the first monitor 112a. The first processor 110a can also perform calculations using the image to determine a camera resolution and/or to determine a contrast for the image. The first processor 110a can activate the first cleaning system 114a to clean the first camera 108a based on the contrast.

The first camera 108a can be a digital camera having an image sensor having an array of pixels. Each pixel can output a voltage corresponding to an intensity of light received at the pixel or a gray scale value recorded at the pixel. Thus, the pixel can output a first gray scale value when a highly reflective portion of an image (such as from a white portion of an image) falls on the pixel and a second gray scale value when a highly non-reflective portion of the image (such as from a black portion of an image) falls on the pixel.

The first camera 108a can have a lens or glass cover for protecting the first camera 108a. The lens or glass cover accumulates water, dirt or other debris which impact a contrast of an image captured by the first camera 108a. The first cleaning system 114a can clean the lens or glass cover using various methods including spraying air, spraying fluid, etc. The first cleaning system 114a can be an integrated component of the first camera, in various embodiments.

Similarly, the second imaging device 106b is operable in the same manner as described herein with respect to the first imaging device 106a. The second imaging device 106b includes a second camera 108b, a second processor 110b, a second monitor 112b and a second cleaning system 114b.

In various embodiments, the first processor 110a and the second processor 110b can be a single processor in communication with their respective cameras. The processor can be included in a controller for the vehicle. The controller may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. The controller may include a non-transitory computer-readable medium that stores instructions which, when processed by one or more processors of the controller, implement a method of determining a resolution of the image and a contrast ratio for an image, activating a cleaning system or cleaning operation to clean the camera based on the contrast ratio and evaluating a new image once the cleaning system has cleaned the camera, according to one or more embodiments detailed herein.

The vehicle 102 can also include an interface 118 for providing information to the driver. The interface 118 can be a heads-up display, a center stack display, or a digital review view mirror display, in various embodiments. The information can be provided as a visual signal, visual message, visual image, etc. The interface 118 can also be a loudspeaker (either integrated into the display or separate from the display) having audio capabilities to transmit a noise or an audio signal. The information can include the results of the cleaning and testing operation.

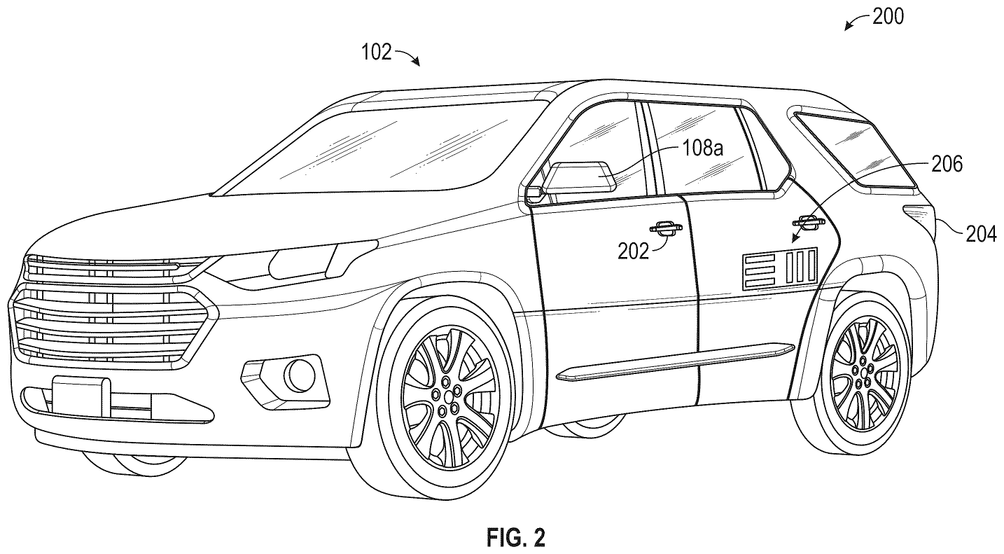

FIG. 2 shows a perspective view 200 of the vehicle 102 at a driver's side of the vehicle. The perspective view 200 shows the first camera 108a and several possible test objects that are within a field of view of the first camera. The first camera 108a can capture an image of the object and a resolution and contrast ratio can determined for the image. Exemplary test objects include a door handle 202, a tail light 204, and a test pattern 206 on a side of the vehicle. In one embodiment, the test pattern 206 can be a printed test pattern. In another embodiment, the test pattern 206 can be a set of LEDs that can be illuminated for the purposes of testing.

As shown in FIG. 2, the test pattern 206 includes a set of horizontal stripes and vertical stripes. The stripes provide an image at the first camera including high intensity portions and low intensity portions.

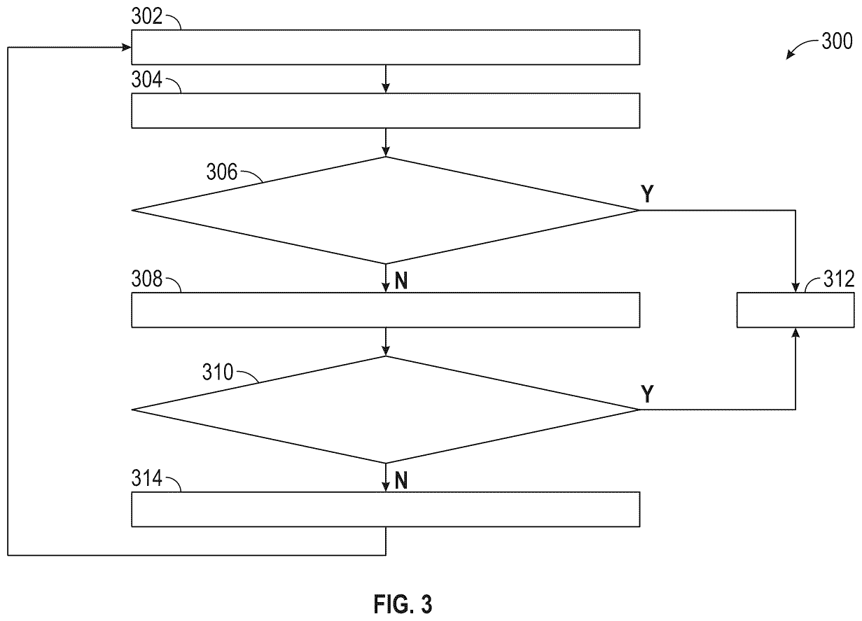

FIG. 3 is a flowchart 300 of a method for operating a cleaning system of the camera, in an embodiment. In box 302, an image is obtained by the camera. In box 304, an image resolution for the image is determined. In box 306, the image resolution is compared to a resolution threshold. If the image resolution is greater than the resolution threshold (i.e., acceptable image resolution), the method proceeds to box 312. In box 312, the method ends. Returning to box 306, if the image resolution is less than or equal to the resolution threshold, the method proceeds to box 308.

In box 308, a contrast ratio of the image is determined. In box 310, the contrast ratio is compared to a contrast threshold. If the contrast ratio is greater than the contrast threshold (i.e., acceptable contrast ratio), the method proceeds to box 312, where the method ends. Returning to box 310, if the contrast ratio is less than or equal to the contrast threshold, the method proceeds to box 314. In box 314, a cleaning signal is sent to the cleaning system to activate the cleaning system. From box 314, the method can return to box 302 to obtain another image, thereby allowing for testing of the results of the cleaning operation.

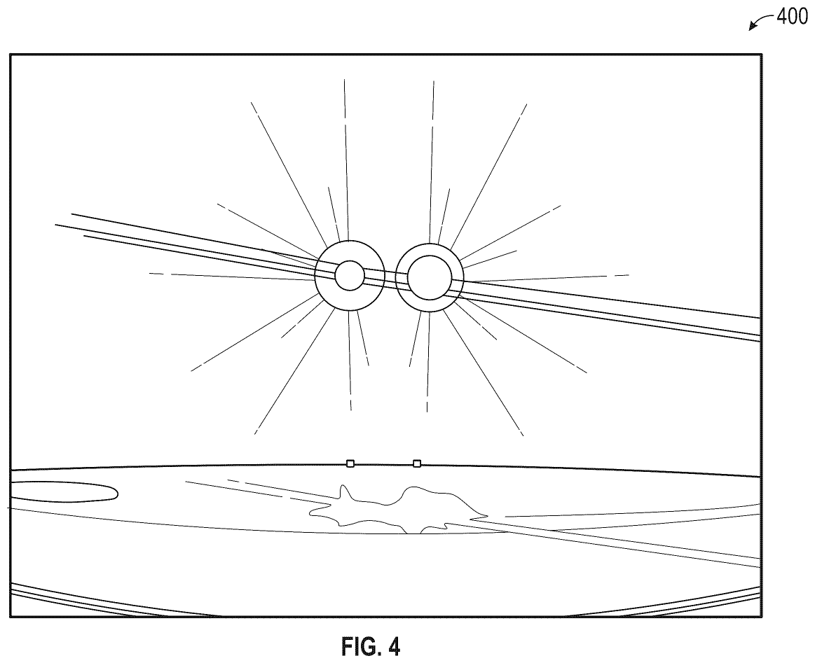

FIG. 4 is an image 400 of a remote vehicle having headlights directed toward a camera. The headlights cause glare to occur in the image resulting in a saturation of the image. The glare can be due to surface imperfections, scratches, contamination or fogging. The resolution of the camera should be sufficient to distinguish the headlights as two distinct headlights rather than one headlight.

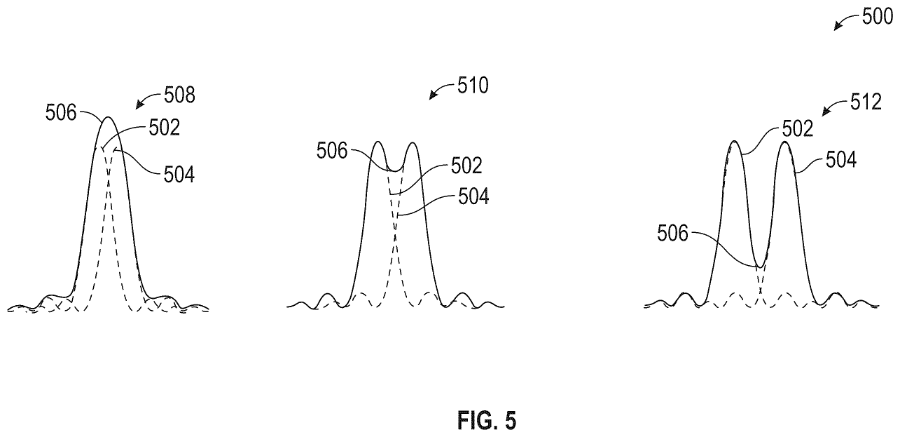

FIG. 5 shows graphs 500 of various levels of resolution for two points. Incoherent image intensity is the convolution of the square of the point spread function and the intensity of an object. A first point spread function 502 and a second point spread function 504 are shown. The first point spread function 502 can be one of the headlights in image 400 and the second point spread function 504 can be the other headlight, for example. A first object point and a second are considered to be just resolved if the maximum of a point spread function of the first object point falls into the minimum of the point spread function of the second object point.

Graph 508 shows an unresolved situation in which an envelope 506 of the superposition of the first point spread function 502 and the second point spread function 504 shows only a single peak. Graph 510 show a just-resolved situation in which the envelope has two peak, the maximum of the first point spread function 502 falling into a first minimum of the second point spread function 504, and vice versa. Graph 512 shows a resolved situation. A resolution of the image can be determined using a modulation transfer function, which can be a slanted edge modulation transfer function, as disclosed herein.

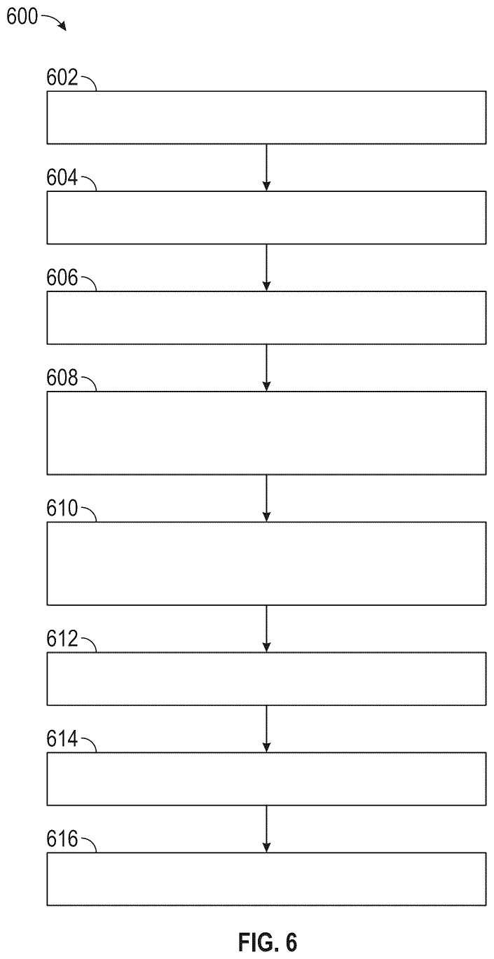

FIG. 6 shows a flowchart 600 of a method of determining a resolution of an image in an illustrative embodiment. In box 602, the image is received from the camera at the processor. In box 604, the image is corrected for distortion due to the curvature of the lens (i.e., wide-angle lens), etc. In box 606, the image is converted to a gray scale. In box 608, an edge spread function is created by projecting two-dimensional array values of the image onto a one-dimensional array.

In box 610, the edge spread function is convolved with a finite impulse response filter to obtain a line spread function. In box 612, a smooth function is applied to the line spread function. In box 614, a discrete Fourier transform is performed over the line spread function to obtain a frequency domain representation of the line spread function. In box 616, the amplitude of the frequency domain representation is plotted to obtain a slanted edge modulation transfer function. The slanted edge modulation transfer function is used to determine a resolution of the image. The resolution quality of the camera system is determined by comparing the resolution with a resolution threshold. If the resolution is less than the resolution threshold, the system can issue an alert to the driver and/or proceed to check a contrast ratio for the image.

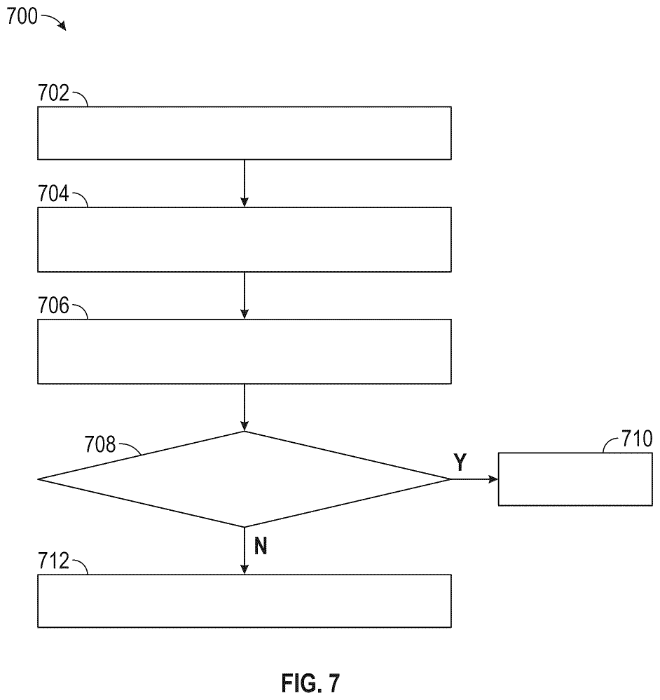

FIG. 7 shows a flowchart 700 illustrating a method for cleaning a camera of the imaging device based on a contrast ratio for the image, in an embodiment. In box 702, an image is received from a camera. The image can include the test object. In box 704, the intensities of each pixel of the image are measured and a maximum intensity (e.g., whitest pixel) is identified and a minimum intensity (e.g., blackest pixel) is identified. The maximum intensity can be represented by a first gray scale value output by a first pixel having a highest intensity or can be an average of gray scale values of a preselected number of pixel having the highest intensities. Similarly, the minimum intensity can be represented by a second gray scale value output by a second pixel having a lowest intensity or can be an average of gray scale values of a preselected number of pixel having the lowest intensities.

In box 706, a contrast ratio C is calculated using the maximum gray scale values and the minimum gray scale values, as shown in Eq. (1):

$$C = \frac{max - min}{max + min} \qquad Eq . ( 1 )$$

where max is the gray scale value of the pixel having the maximum intensity and min is the gray scale value of the pixel having the minimum intensity. In box 708, the contrast ratio is compared to a contrast threshold. If the contrast ratio is greater than a contrast threshold (i.e., indicating an acceptable level of contrast for the camera), the method proceeds to box 710. In box 710, the method ends.

Returning to box 708, if the contrast ratio is less than or equal to the contrast threshold, the method proceeds to box 712. In box 712, the cleaning system is activated to clean the camera (e.g., to clean the glass cover).

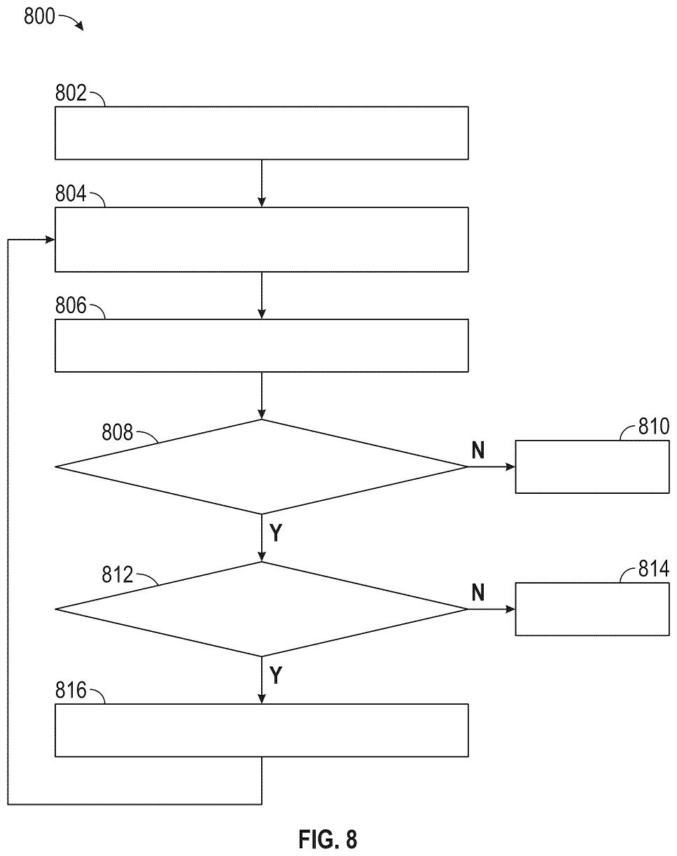

FIG. 8 shows a flowchart 800 illustrating a method for determining a terminus for a cleaning operation, in an embodiment. The method includes activating the cleaning system a selected number of times either until the contrast ratio of the image has improved above a contrast threshold or until the number of times the cleaning system has been activated exceeds a count threshold. In box 802, a counter is initialized at zero. In box 804, an image (a first image) is obtained at the first camera and a contrast ratio of the image is determined or calculated. In box 806, the counter is increased by one. In box 808, the contrast ratio is compared to a contrast threshold to determine whether to activate a cleaning system for the camera. If the contrast ratio is greater than or equal to the contrast threshold (i.e., no cleaning is needed), the method proceeds to box 810. In box 810, the cleaning operation is stopped.

Returning to box 808, if the contrast ratio is less than the contrast threshold (i.e., cleaning is needed), the method proceeds to box 812. In box 812, the counter is compared to a count threshold. If the counter is equal to or greater than the count threshold, the method proceeds to box 814. In box 814, the processor sends an alert signal to the driver. The alert signal can take the form of a message for display at the monitor or an audible signal. The cleaning operation is then stopped.

Returning to box 812, if the counter is less than the count threshold, the method proceeds to box 816. In box 816, the cleaning system is activated to clean the camera. From box 816, the method returns to box 804 in which a second or subsequent image is captured. In box 804, the contrast ratio can be obtained for the subsequent image. Alternatively, the resolution can be checked in box 804 and the contrast ratio can be obtained if the resolution is unacceptable (i.e., less than a resolution threshold). The method then proceeds to either clean the camera at a second or subsequent time (box 816) or end the process (box 810 or box 814) based on the second or subsequent image.

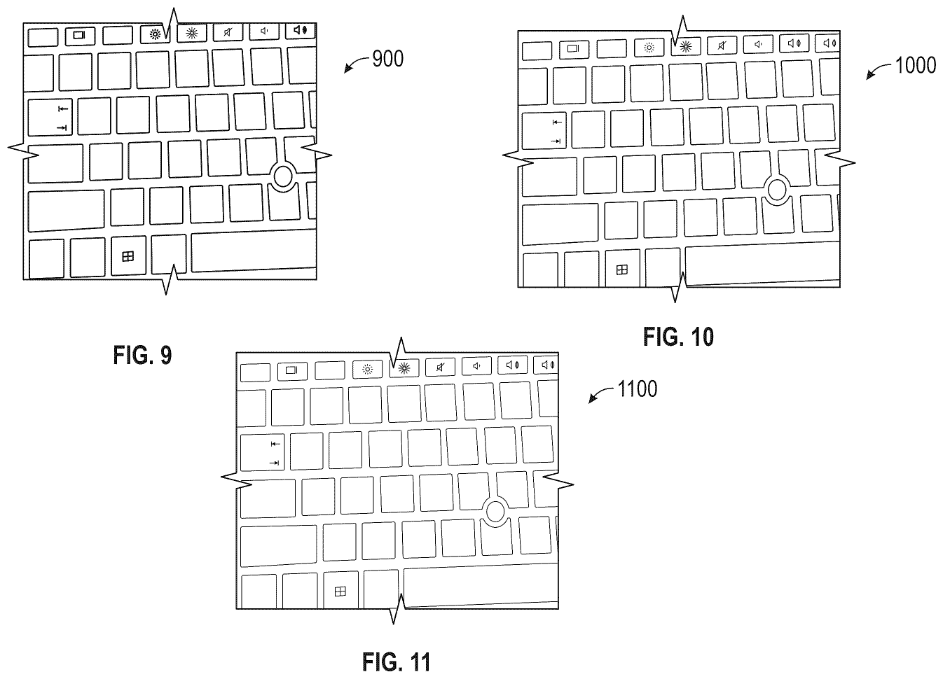

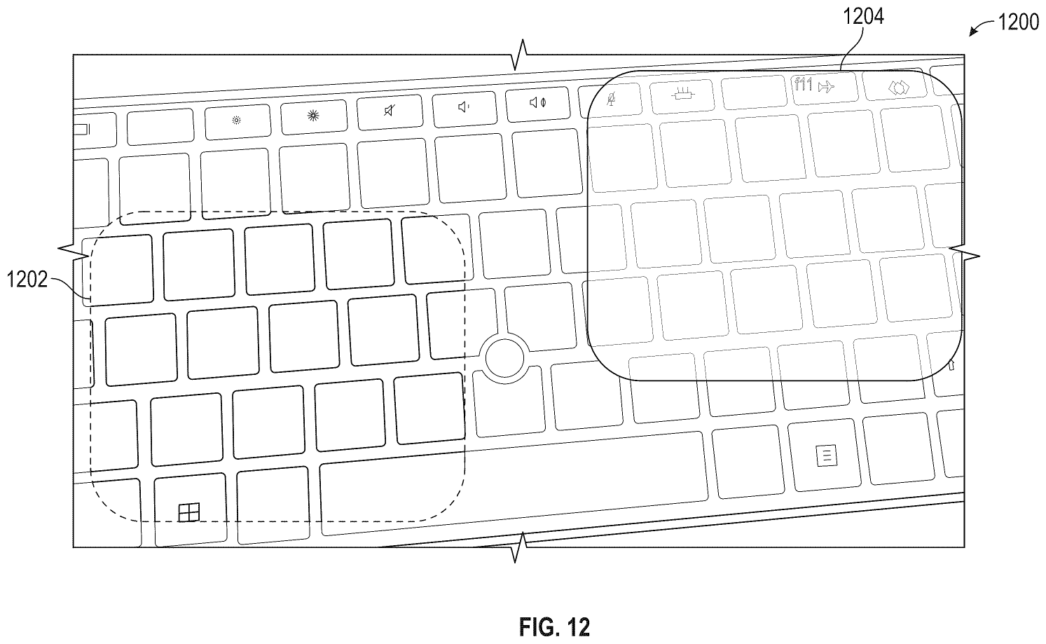

FIGS. 9-11 shows an image having different levels of contrast ratios, for illustrative purposes. FIG. 9 shows an illustrative image 900 of a test pattern having black (low intensity) and white (high intensity) portions. The illustrative image 900 has a contrast ratio of 100%. FIG. 10 shows a second image 1000 of the test pattern taken by a camera experiencing a reduced image contrast due to a light accumulation of water. The second image 1000 has a contrast ratio of 80%. FIG. 11 shows a third image 1100 of the test pattern taken by the camera experiencing a reduced image contrast due to a heavy accumulation of water. The third image 1100 has a contrast ratio of 45%. FIG. 12 shows a fourth image 1200 of the test pattern taken by the camera experiencing a reduced image contrast due to an accumulation of dirt. The fourth image 1200 has a contrast ratio of 95%.

The fourth image 1200 also illustrates a contrast test using image segmentation. For illustrative purposes, the fourth image 1200 is segmented into two separate regions and a contrast ratio is calculated for each region. However, in other embodiments, an image can be segmented into any number of regions. A first region 1202 is clear of debris while a second region 1204 has an accumulation of dirt. A contrast ratio is determined for each of the first region 1202 and the second region 1204 separately. The first region 1202 has a first contrast ratio of 100% while the second region has a second contrast ratio of 90%. The overall contrast ratio for the image is an average of the first contrast ratio and the second contrast ratio is about 95%. When a contrast threshold is set at, for example, 92%, the contrast of the entire image (i.e., 95%) is considered acceptable. However, the cleaning system is activated when at least one of first contrast ratio and the second contrast ratio is less than the contrast threshold. In the fourth image 1200, the second contrast ratio (i.e., 90%) is less than this contrast threshold (i.e., 92%). Therefore, the cleaning system is activated.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of operating a camera of an imaging device of a vehicle, comprising:
obtaining a first image of a test object via the camera, the camera including an image sensor with an array of pixels;
determining a resolution of the first image;
comparing the resolution to a resolution threshold;
determining a contrast ratio of the first image at a processor when the resolution is less than the resolution threshold, wherein the contrast ratio is based on a difference between a first gray scale value for a first pixel of the first image having a maximum intensity and a second gray scale value for a second pixel of the first image having a minimum intensity;
comparing the contrast ratio to a contrast threshold at the processor;
performing, via the processor, a cleaning operation to clean the camera when the contrast ratio is less than the contrast threshold;
obtaining a second image of the test object; and
sending an alert signal to a driver of the vehicle based on the second image.

2. The method of claim 1, further comprising segmenting the first image into at least a first region and a second region, determining a first contrast ratio for the first region and a second contrast ratio for the second region, and performing the cleaning operation when at least one of the first contrast ratio and the second contrast ratio is less than the contrast threshold.

3. The method of claim 1, further comprising determining the resolution of the first image using a modulation transfer function.

4. The method of claim 1, wherein the test object is at least one of: (i) a door handle of the vehicle; (ii) a tail light of the vehicle; (iii) a test pattern printed on the vehicle within a field of view of the camera; and (iv) a set of LEDs on the vehicle and within the field of view of the camera.

5. The method of claim 1, further comprising performing the cleaning operation at a subsequent time when the contrast ratio of the second image is less than the contrast threshold.

6. The method of claim 1, wherein the alert signal is at least one of: (i) a visual signal; and (ii) an audio signal.

7. The method of claim 1, further comprising sending the alert signal when at least one of: (i) the resolution of the second image is less than the resolution threshold; and (ii) the contrast ratio of the second image is less than the contrast threshold.

8. An imaging device for a vehicle, comprising:
a camera including an array of pixels;
a cleaning system;
a processor configured to:
obtain a first image of a test object via the camera;
determine a resolution of the first image;
compare the resolution to a resolution threshold;
determine a contrast ratio of the first image when the resolution is less than the resolution threshold, wherein the contrast ratio is based on a difference between a first gray scale value for a first pixel of the first image having a maximum intensity and a second gray scale value for a second pixel of the first image having a minimum intensity;
compare the contrast ratio to a contrast threshold;
activate the cleaning system to clean the camera when the contrast ratio is less than the contrast threshold;
obtain a second image of the test object; and
send an alert signal to a driver of the vehicle based on the second image.

9. The imaging device of claim 8, wherein the processor is further configured to segment the first image into at least a first region and a second region, determine a first contrast ratio for the first region and a second contrast ratio for the second region, and activate the cleaning system when at least one of the first contrast ratio and the second contrast ratio is less than the contrast threshold.

10. The imaging device of claim 8, wherein the processor is further configured to determine the resolution of the first image using a modulation transfer function.

11. The imaging device of claim 8, wherein the test object is at least one of: (i) a door handle of the vehicle; (ii) a tail light of the vehicle; (iii) a test pattern printed on the vehicle within a field of view of the camera; and (iv) a set of LEDs on the vehicle and within the field of view of the camera.

12. The imaging device of claim 8, wherein the processor is further configured to activate the cleaning system at a subsequent time when the contrast ratio of the second image is less than the contrast threshold.

13. The imaging device of claim 8, further comprising an interface for providing the alert signal to the driver as at least one of: (i) a visual signal; and (ii) an audio signal.

14. The imaging device of claim 8, wherein the camera is located at a side of the vehicle.

15. A vehicle, comprising:
a test object located on the vehicle;
an imaging system including:
a camera including an image sensor having an array of pixels;
a cleaning system for cleaning a glass surface of the camera;
a processor configured to:
obtain a first image of the test object via the camera;
determine a resolution of the first image;
compare the resolution to a resolution threshold;
determine a contrast ratio of the first image when the resolution is less than the resolution threshold, wherein the contrast ratio is based on a difference between a first gray scale value for a first pixel of the first image having a maximum intensity and a second gray scale value for a second pixel of the first image having a minimum intensity;
compare the contrast ratio to a contrast threshold;
activate the cleaning system to clean the camera when the contrast ratio is less than the contrast threshold;
obtain a second image of the test object; and
send an alert signal to a driver of the vehicle based on the second image.

16. The vehicle of claim 15, wherein the processor is further configured to segment the first image into at least a first region and a second region, determine a first contrast ratio for the first region and a second contrast ratio for the second region, and activate the cleaning system when at least one of the first contrast ratio and the second contrast ratio is less than the contrast threshold.

17. The vehicle of claim 15, wherein the processor is further configured to determine the resolution of the first image using a modulation transfer function.

18. The vehicle of claim 15, wherein the test object is at least one of: (i) a door handle of the vehicle; (ii) a tail light of the vehicle; (iii) a test pattern printed on the vehicle within a field of view of the camera; and (iv) a set of LEDs on the vehicle and within the field of view of the camera.

19. The vehicle of claim 15, wherein the processor is further configured to activate the cleaning system at a subsequent time when the contrast ratio of the second image is less than the contrast threshold.

20. The vehicle of claim 15, further comprising an interface for providing the alert signal to a driver as at least one of: (i) a visual signal; and (ii) an audio signal.
